(19) United States
(12) Patent Application Publication
(10) Pub. No.: US 2008/0068830 A1
(43) Pub. Date: Mar. 20, 2008

(54) Wall, headboard or ceiling mounted cordless illuminating device

(76) Inventor: Murari Sharma, Gaithersburg, MD (US)

Correspondence Address: MURARI SHARMA, 15315 CHINABERRY STREET, GAITHERSBURG, MD, 20878, US

(21) Appl. No.: 11/896,143

(22) Filed: Aug. 30, 2007

Related U.S. Application Data
(60) Provisional application No. 60/840,942, filed on Aug. 30, 2006.

(51) Int. Cl. F21L 4/00; F21S 8/00

(52) U.S. Cl. 362/147

(57) ABSTRACT

An illumination device that can mount to a surface that includes a track for movement in one plane, and is powered by conventional or rechargeable batteries, that can be mounted to a surface such as a wall, headboard or ceiling. The features of the device allow for the elimination of electrical outlets and the spectacle of exposed electrical cords extending down the wall and also allow in the case of use as a reading light mounted behind the bed, a light source that can be adjusted horizontally so as to enable users to position it optimally for reading, without a person's head or other object to be in the way. The device can also feature swivel points to ensure the light is directed towards the reading material.

Reference is made to provisional Patent Application No: 60/840,942 with a filing date of Aug. 30, 2006 and Confirmation No: 1939, Applicant: Murari Sharma of 15315 Chinaberry Street, Gaithersburg, Md. 20878.

### BACKGROUND OF THE INVENTION

The present invention relates to an illuminating device mounted on a wall, particularly in use as a light over a bed. As a variation, it could also be mounted on a headboard, for spotlight other objects with means to power said light with batteries or rechargeable batteries so that the power cord can be eliminated. Other possible uses for this invention would be as a lamp that can spotlight paintings or pictures on the wall, or as a lamp that can be installed over a desk for reading and other work, or as a self contained light that can be installed in shelves or cabinets.

The present invention is unique in that it combines the use of a battery operated lamp with the use of a track for positioning, the combination of these two features is not to be found in the prior art that was searched.

Heretofore, varied lamps that include tracks have been proposed and produced, but none being powered by batteries or rechargeable batteries. These include “The Bedtime Dual Flex Lamp” (Listed under “Other Publications” in the Information Disclosure Statement). This prior art includes a track, but not battery powered operation.

Varied lamps have also been proposed as exemplified by U.S. Pat. No. 5,727,868 (Sharma) that are powered by batteries or rechargeable batteries, but does not combine the use of tracks or railings.

The battery operated feature is desirable because the unsightliness of a power cord leaves the user with the choice of either masking the cord by covering it, which requires effort in installation and leaves a cord cover visible; or, the choice of going through the lengthy or difficult process of routing the wire behind the wall and also connecting the power to the cord from behind the wall. The battery operated feature is also desirable because, although this invention can be used with any form of light source, the advent of efficient lamps such as led (light emitting diode) lamps makes the use of batteries much more practicable than before.

The track feature is desirable because of the obvious ability to position the lamp, in the case of reading in bed, to ensure that a person's head does not come in the way of the emitted light, especially because people, as well as beds, are not of one size, so the flexibility is needed. The present invention has the flexibility of being easily mounted on a surface such as a wall or a headboard or a ceiling, at the discretion of the user, after the user has assessed the type of wall or bed or normal position while reading.

The battery powered feature can be added to all forms of presently existing wall mounted lamps, using a variety of illumination sources such as halogen, incandescent, fluorescent, led (light emitting diode) and others.

### SUMMARY OF THE INVENTION

It is an object of the present invention to provide a wall, headboard or ceiling mounted lamp which can be powered by batteries or rechargeable batteries and uses a track for movement and adjustment.

It is also an object of the present invention to provide a lamp where the lamp can be slim and of low profile whereby if mounted behind a bed, is unobstrusive and easy to use.

Another object of the present invention is to provide a lamp where user replaceable parts, namely the batteries and lamps, are easily replaced by the user, without the need for tools.

Yet another object of the lamp is to provide a lamp where user replaceable parts, namely the batteries and lamps, are easily available at low cost.

It is a further object of the present invention to provide a wall mounted lamp that is easy to manufacture and operate.

The entire invention can be easily constructed of stamped, extruded or molded material and is provided with all of the features for placement necessary to house on a headboard or above a headboard on the wall.

### SHORT DESCRIPTION OF THE DRAWINGS

FIG. 1 is a perspective view of the preferred embodiment of the invention.

FIG. 2 is an sectional, exploded perspective view of the contact and lamp connections for the preferred embodiment

FIG. 3 is sectional, exploded, perspective view of the battery placement and wall mounting features of the preferred embodiment of the invention.

FIG. 4 is a circuit diagram of the preferred embodiment.

FIG. 5 is a sectional, exploded, perspective view of the preferred embodiment using a flexible or “gooseneck” arrangement for connecting to and positioning the lamp.

FIG. 6 is a sectional perspective view showing the points of flexibility for positioning of the preferred embodiment.

FIG. 7 is a sectional perspective view showing a method for recessing the railings of the invention into the base housing.

FIG. 8 is a sectional, exploded view of an alternate placement of the switch for the invention.

FIGS. 9A and 9B show two additional embodiments for the invention, based on having the batteries placed in the end pieces with the railing in between said end pieces.

### DETAILED DESCRIPTION OF THE DRAWINGS

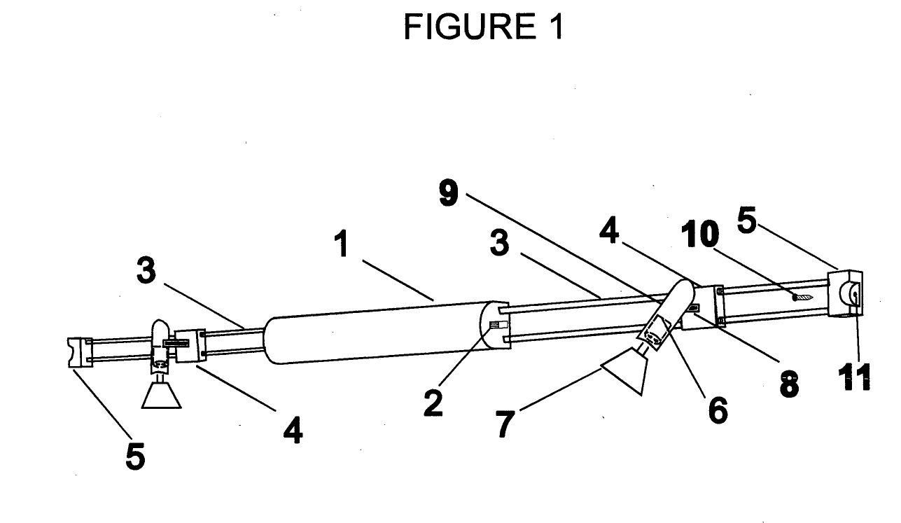

FIG. 1 is a perspective view of the assembled lamp, in the preferred embodiment.

Referring to FIG. 1, The lamp consists of a base 1 that houses the switch 2 and/or electronics and/or batteries or rechargeable batteries, railings 3 to make the horizontal position variable, “contact” modules 4 that slide on the railing (and may also be used to house the switch and/or electronics and/or batteries), and end pieces 5 that hold the railing 3 to the wall (and may also be used to house the switch and/or electronics and/or batteries).

The “contact” modules 4 each attach to a stem 8 that is connected on the other end to a lamp or socket 6 for a lamp 7.

The socket 6 may be covered by a decorative shade 9. The end pieces 5 may be attached to the wall by using a screw 10 that goes through the hole 11 and then into a wall or headboard. Alternatively, the end pieces 5 may be attached to the wall using other methods such as double sided tape.

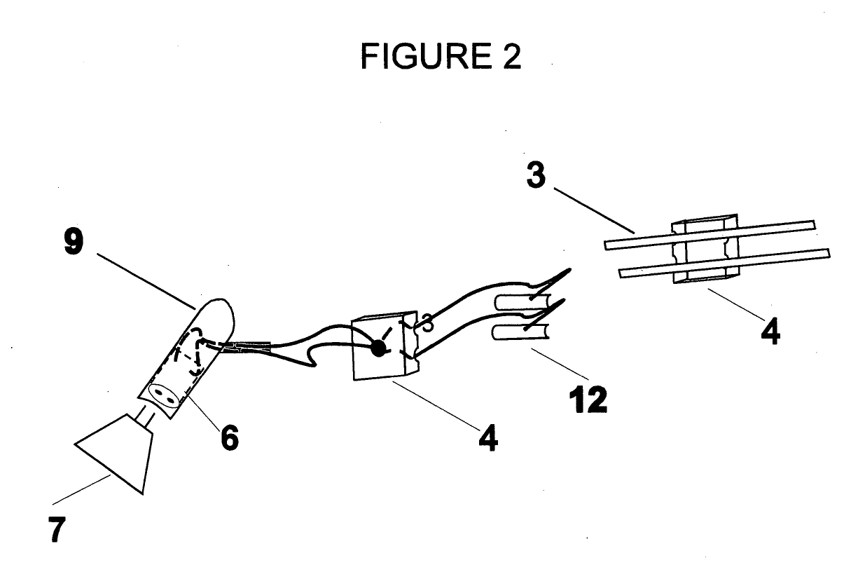

FIG. 2 is a perspective view of the contact and lamp connections. Referring to FIG. 2, The “contact” modules 4 would have means to slide on the railings 3, as well as to electrically provide conductivity to the lamp or lamp socket. Electrical conduction begins with a pair of electrical contacts 12 that are electrically conductive and of a shape to conform to the railings 3, then the wires 13 go into the decorative shade 9 and conduct the electricity to the lamp socket 6 to power the lamp 7.

Further, the base 1 has means to mount the base to the wall, either by holes through which screws can be put through in order to affix the base to the wall, alternatively, other means such as double sided tape may be used to mount the base to the wall.

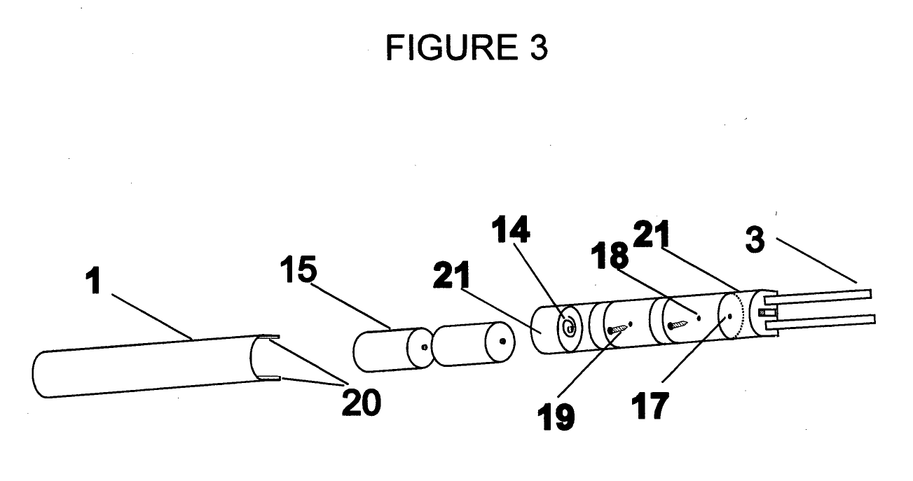

FIG. 3 shows how the method of placing the batteries into the base 1, where the inner base 14 can be made of plastic or other material that can be molded or extruded.

The inner base 14 would have means to have placed inside and to electrically contact the batteries (or rechargeable batteries) 15 through the spring 16 and opposite contact 17. The inner base 14 may have holes 18 through which the screws 19 can go through and be screwed into a wall or headboard. The base 1 may be made with right angle bends 20 so that the base 1 cover can slide over the inner base 14 and not fall off when the lamp is completely assembled. The end parts 21 of the inner base 14 may be used to house the circuit and switch for each lamp.

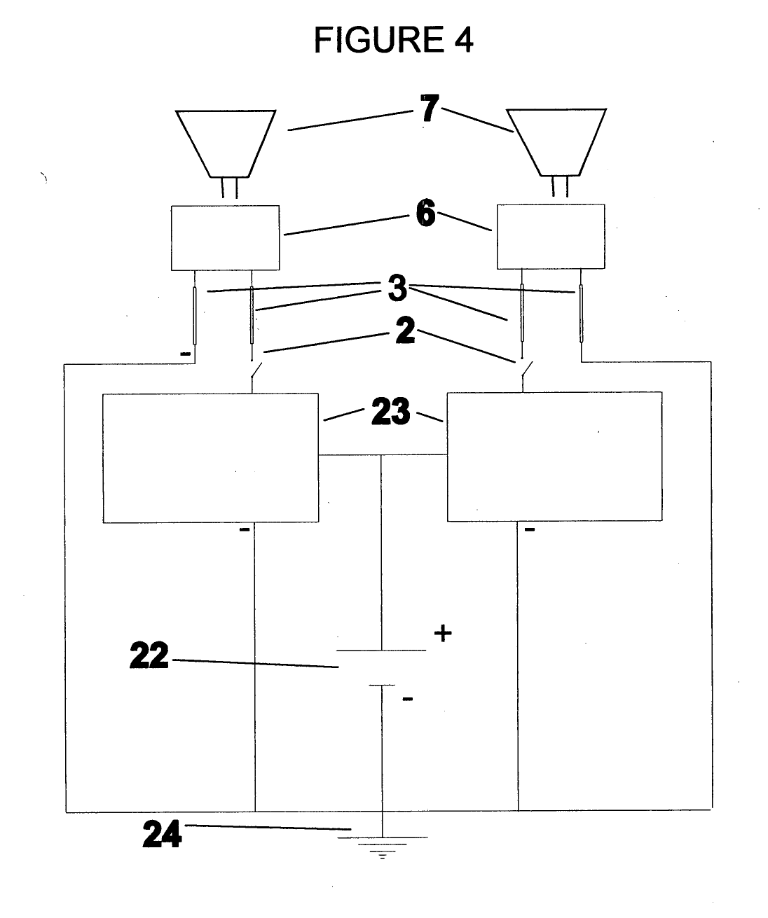

Referring to FIG. 4, the electrical circuit is comprised of a set of batteries 22 of conventional or rechargeable type where the negative terminal is connected to the negative terminals of the circuit 23, to ground 24 and to the railing 3 carrying the negative side. The positive terminal is connected to the positive input of the circuit 23. The positive output from the circuit 23 is connected to the switches 2, after which electrical connection is made to the railings 3 and into the sockets 6 and then to the lamps 7. In the case that a lamp 7 is directly connected, without the sockets 6, the sockets 6 can be eliminated.

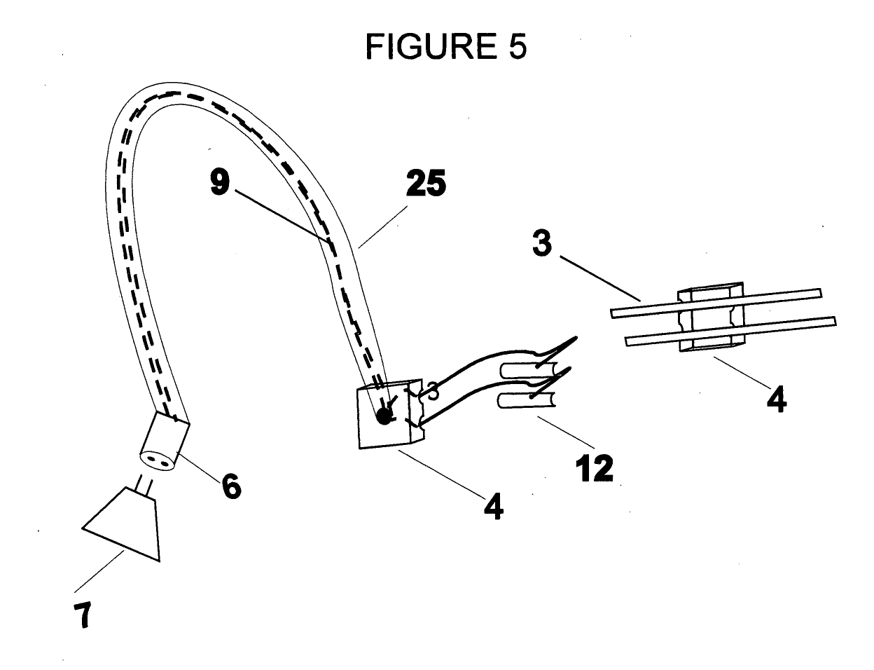

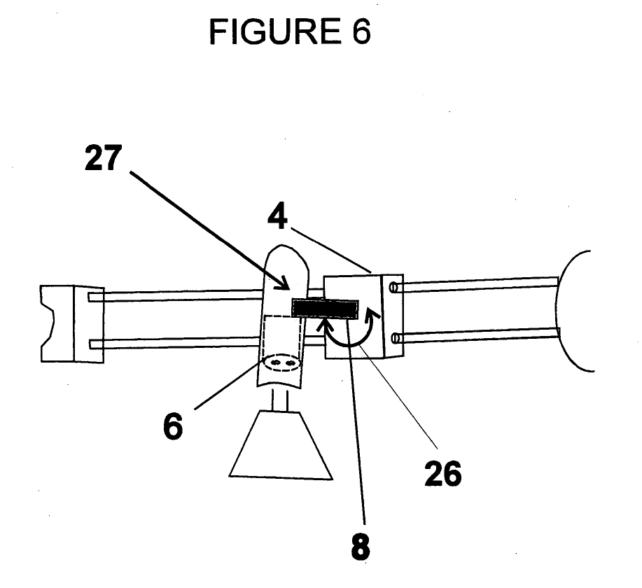

Referring to FIG. 5, if a flexible, or commonly known as a “gooseneck” stem is used, the figure shows how the stem 25 can be connected from the “contact” modules 4 to the sockets 6. Referring to FIG. 6, the rotation points of the preferred embodiment are shown, where 26 shows where there can be up to 360 degrees circular movement in two dimensions at the point where the stem 8 meets the “contact” module 4, and there can be a 360 degree swivel movement in three dimensions at the point 27 where the stem 8 meets the lamp socket 6.

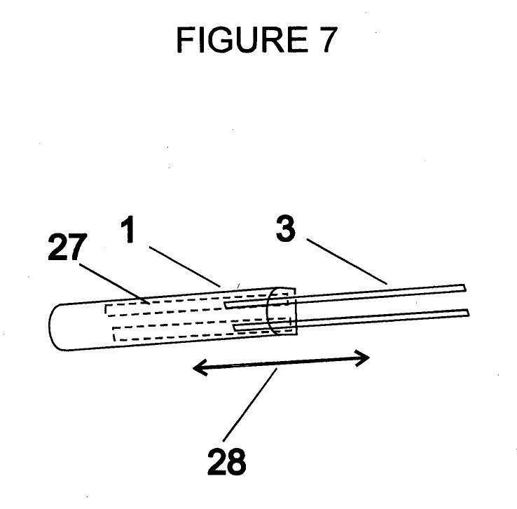

Referring to FIG. 7, an alternate embodiment is shown, whereby hollow channels 27 can be used in order to make the railings 3 collapsible into the base housing 1. the direction of movement is shown by the arrow 28.

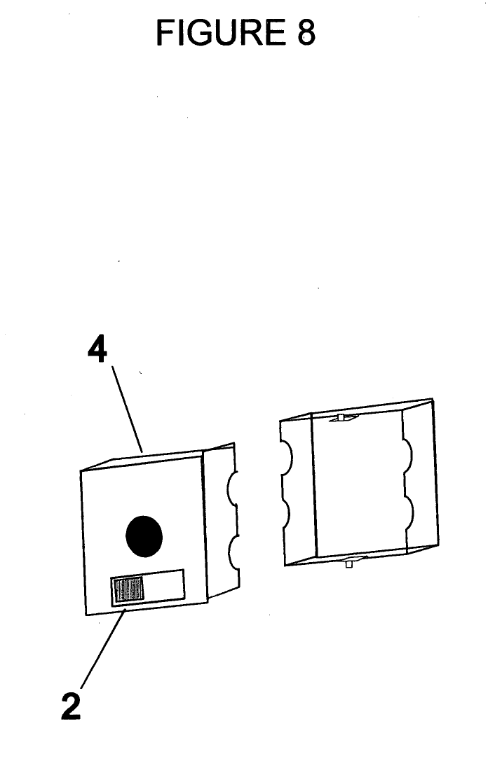

Referring to FIG. 8, an alternate location for the switch is shown, whereby the switch 2 is on one of the faces of the “contacting” module 4.

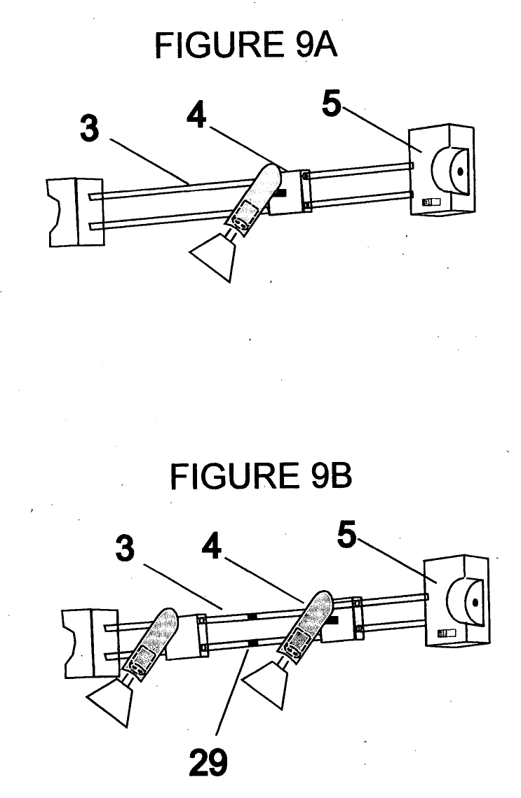

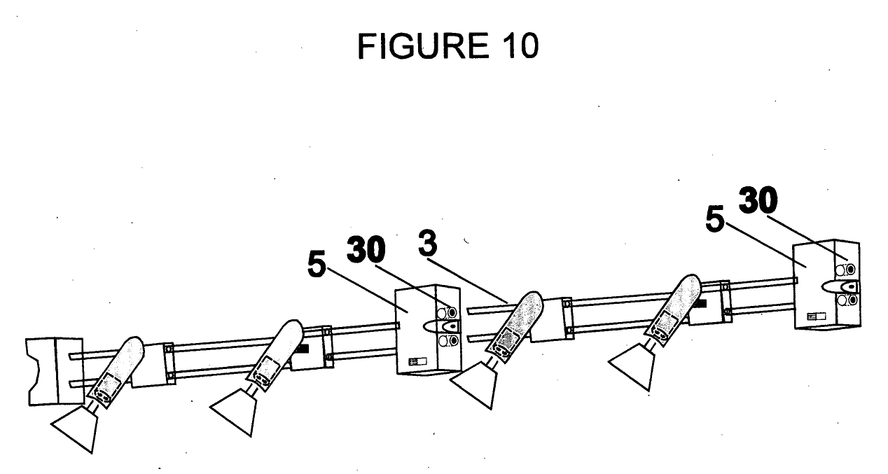

Referring to FIG. 9A, an alternate embodiment is shown where the base is eliminated, and batteries or rechargeable batteries can be housed in the enlarged end pieces 5, or in the “contacting” module 4. This view depicts an arrangement with one lamp whereas the railings 3 is continuous. A plurality of lamps may be used, provided it is acceptable to have the same switching arrangement as a control the plurality of lamps.

Referring to FIG. 9B, an alternate embodiment is shown similar to FIG. 9A, however, if each railing 3 is cut at some point, and a non-conductive piece of material 29 is placed at the cut, so that the two ends of each said railing 3 do not conduct electricity, lamps or a plurality of lamps can be powered and controlled separately, from each of the respective end pieces 5.

Referring to FIG. 10, an alternate embodiment is shown where there is provision for the lamp to be made in a way as to make modular pieces that fit together as a “track” light. If one end of the railings 3 is left without and end piece or other piece, and if indentations 30 are made in the end piece of the other side, the railings 3 of one piece can be made to fit into the receptacle made by the indentations 30. Thus, extendable track lights can be made and separate lamp modules (including the “contacting” module 8, the stem 6, the shade 9, the socket 6 and the lamps 7) can be made and provided to a user depending on how many lamps and plurality of lamps are desired.

From the foregoing description it should be apparent that the present invention provides many features that are entirely new in a battery operated lamp, in particular the combination with a track mechanism allows great advantages in positioning of the lamp or lamps. Particularly with the advent of energy efficient lamps such as light emitting diodes, the present invention makes the idea of cordless track lighting much more feasible than in the past.

A variety of uses can be imagined for the present invention, such as for a cordless picture lamp, cordless lamp mounted over a table as a work light, cordless track lighting, cordless reading light, under counter or under cabinet lighting, etc.

It is also imaginable to add remote control features to the invention, in order to control the mechanical movement and/or the switch and dimming for the lamp.

What I claim is:

1. A wall or headboard or ceiling mounted, cordless illuminating device comprising:
a track or plurality of tracks that may consist of a railing or plurality of railings;
a means to house a battery or plurality of batteries, conventional or rechargeable, and
circuits and switches or plurality of circuits and switches; a stem or plurality of stems that is mounted to a housing that contacts said track or plurality of tracks;
said stem is connected to a lamp socket or plurality of lamp sockets, whereby a lamp or plurality lamps may be removeably mounted; or said stem may be connected directly to the lamp or plurality of lamps; said device having means to be mounted to a wall, headboard or ceiling.

2. A wall or headboard or ceiling mounted, cordless illuminating device of claim 1, wherein the housing for the battery or plurality of batteries, consists of a generally semicircular shape; said housing having means to be mounted to a wall, headboard or ceiling, and connecting to a track or plurality of tracks that connect at their endpoint to an end piece, generally of rectangular shape; said circuit or plurality of circuits and switch or plurality of switches housed in either the same housing as the batteries or plurality of batteries, or the said end pieces or the said contact piece.

3. A wall or headboard or ceiling mounted cordless illuminating device of claim 1, wherein the railing or plurality of railings are made to be collapsible into a housing, allowing for linear movement in one plane of the railing or plurality of railings and also the lamp or plurality of lamps.

4. A wall or headboard or ceiling mounted cordless illuminating device of claim 1, wherein the railing or plurality of railings are made to be collapsible into a housing, allowing for linear movement in one plane of the railing or plurality of railings; said railings having an end piece that also is a contact and housing for the lamp or plurality of lamps, where the lamp or plurality of lamps is not allowed to slide on the track, but only the collapsible movement allows for their linear movement in one plane.

5. A wall or headboard or ceiling mounted cordless illuminating device of claim 1, wherein the track or plurality of tracks are collapsible, as in a radio antennae.

6. A wall or headboard or ceiling mounted cordless illuminating device of claim 1, wherein the track is between housings that house the batteries and/or the switches and/or the circuits.

7. A wall or headboard or ceiling mounted cordless illuminating device of claim 1, wherein a housing is only on one side of the tracks, said housing being able to house the batteries and/or the switches and/or the circuits, and said housing also being able to join with the open end of another track or set of tracks.

8. A wall or headboard or ceiling mounted cordless illuminating device of claim 1, wherein the stem or plurality of stems are collapsible, as in a radio antennae.

9. A wall or headboard or ceiling mounted cordless illuminating device of claim 1, wherein the lamp or plurality of lamps travel along a track or plurality of tracks only for positioning, but the tracks are not used for electrical conduction, rather the lamps are wired to achieve the electrical conduction.
